(19) United States
(12) Patent Application Publication
(10) Pub. No.: US 2008/0093379 A1
(43) Pub. Date: Apr. 24, 2008

(54) Collapsible tube construction

(76) Inventor: K. Jacques Sassouni, Great Neck, NY (US)

Correspondence Address: Charles E. Temko, Esq., 22 Marion Road, Westport, CT, 06880, US

(21) Appl. No.: 11/636,671

(22) Filed: Dec. 11, 2006

Related U.S. Application Data
(60) Provisional application No. 60/853,537, filed on Oct. 23, 2006.

(51) Int. Cl. B65D 35/00; B65D 47/00; B29C 45/14

(52) U.S. Cl. 222/107; 222/556; 29/428; 264/259

(57) ABSTRACT

A collapsible tube construction for dispensing a fluid material such as toothpaste, and the like, which employs a hinged lid or closure. The construction includes a shoulder element having a dispensing orifice which seals an open end of the tube when engaged by the lid element. One of the lid element and shoulder element forms a recess communicating with the periphery thereof, the other of said lid element and shoulder element forming an axially-extending tab including a hinge, and end portion of the tab engaging the recess to be retained therein. An inner surface of the lid element includes an axially-aligned projection which selectively engages the dispensing orifice when the lid element is in closed condition.

### RELATED APPLICATION

Reference is made to my copending application Ser. No. 60/853,537 filed Oct. 23, 2006 to which a claim of priority is made.

### BACKGROUND OF THE INVENTION

This invention relates generally to the field of collapsible tubes, typically a tube containing cream, lotion, gel, toothpaste, or similar products, and more particularly to an improved construction in which the requirement for a threaded closure is eliminated. It is known in the art to form the tube from synthetic resinous or metallic material with one end sealable after filling the tube, and the opposite end forming a shoulder having a threaded neck extending therefrom upon which a threaded cap is selectively positioned. For convenient use it is known to provide the threaded closure with a pivotally mounted portion which may be manually moved to open condition without an unthreading operation. The above construction has a degree of complexity during manufacture, and thus there arises a need for simplification of such manufacture incorporating improved convenience for the user.

### SUMMARY OF THE INVENTION

Briefly stated, the invention contemplates the provision of a collapsible tube element and a separately molded shoulder element simultaneously heat-sealed upon an end of the tube element. The shoulder element includes a hollow recess. A closure element includes a lid selectively overlying the shoulder element having a hinged area and a tab projecting from the hinged area into the recess in the shoulder element to be retained in place. The shoulder element includes a centrally positioned dispensing orifice closed by the lid. The tube is filled at an opposite end and sealed in known manner. In use, the orifice is opened by flipping the cap to open position without the need of unthreading, thus enabling one hand manipulation by the user. The lid includes a projection on an inner surface thereof which selectively engages the dispensing orifice in the shoulder element to maintain the orifice in closed condition. In a second embodiment, the shoulder element includes the tab projecting from the hinged area, and the recesses formed in the lid element.

### BRIEF DESCRIPTION OF THE DRAWINGS

In the drawings, to which reference will be made in the specification, similar reference characters have been employed to designate corresponding parts throughout the several views.

FIG. 1 is a perspective view of an embodiment of the invention with certain parts removed for purposes of an embodiment of the invention with certain parts removed for purposes of clarity.

FIG. 2 is a central sectional view thereof.

FIG. 3 is a top plan view of a lid element forming part of the embodiment.

FIG. 4 is a central sectional view of the lid element as seen from the plane 44 in FIG. 3.

FIG. 5 is a central sectional view of a second embodiment of the invention with lid element removed.

FIG. 6 is a top plan view of the shoulder element of the second embodiment.

FIG. 7 is a central sectional view of the lid element of the second embodiment.

### DETAILED DESCRIPTION OF THE DISCLOSED EMBODIMENT

In accordance with the first embodiment of the invention, the device, generally indicated by reference character 10, comprises broadly; a tube element 11, a shoulder element 12, and a pivotal cap element 13, all of which are formed of synthetic resinous heat sealable material.

The tube element 11 is a generally cylindrical configuration, and may be formed by transversely cutting an extruded hollow tube at desired intervals. It includes the first end used for filling the contents (not shown) and a second end 21 which is fused to the shoulder element during a compression molding process of the shoulder element. It includes an inner surface 22 and an outer surface 23.

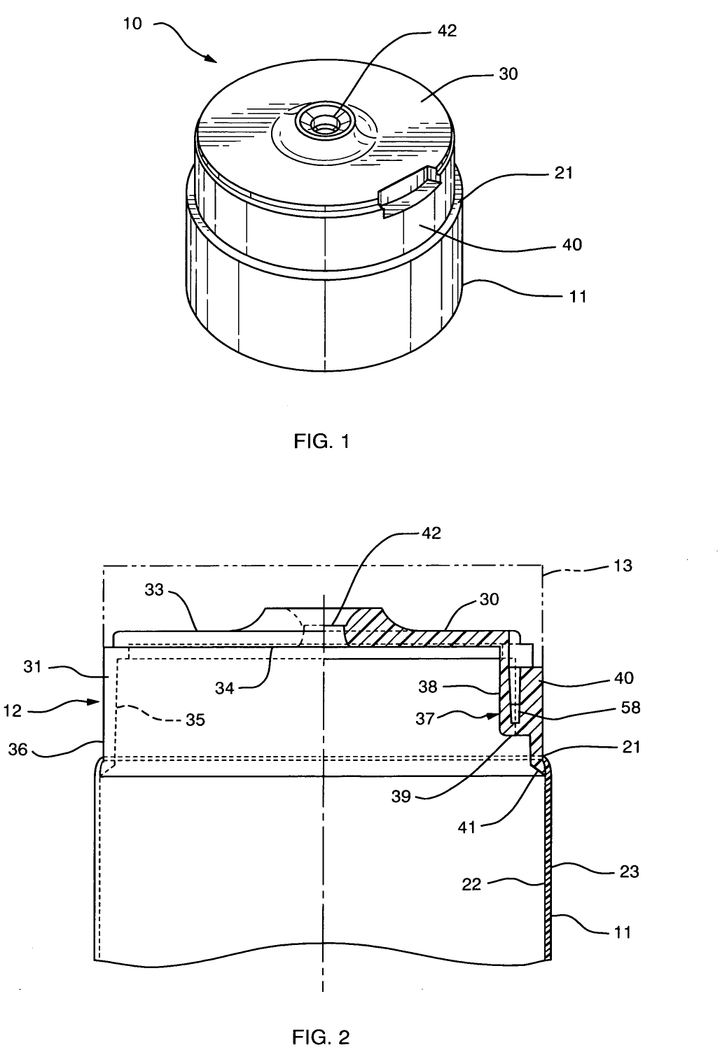

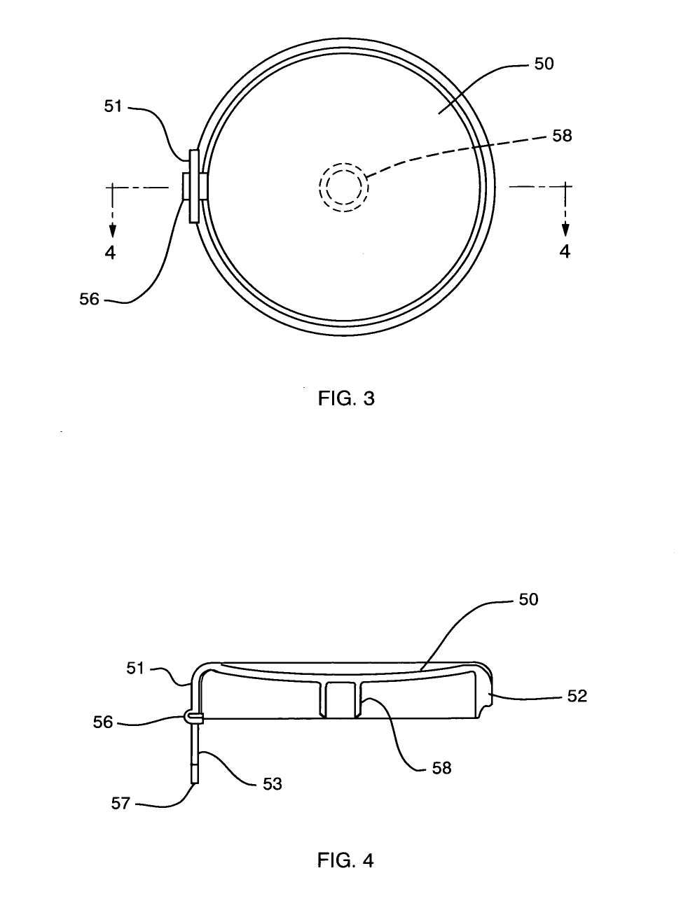

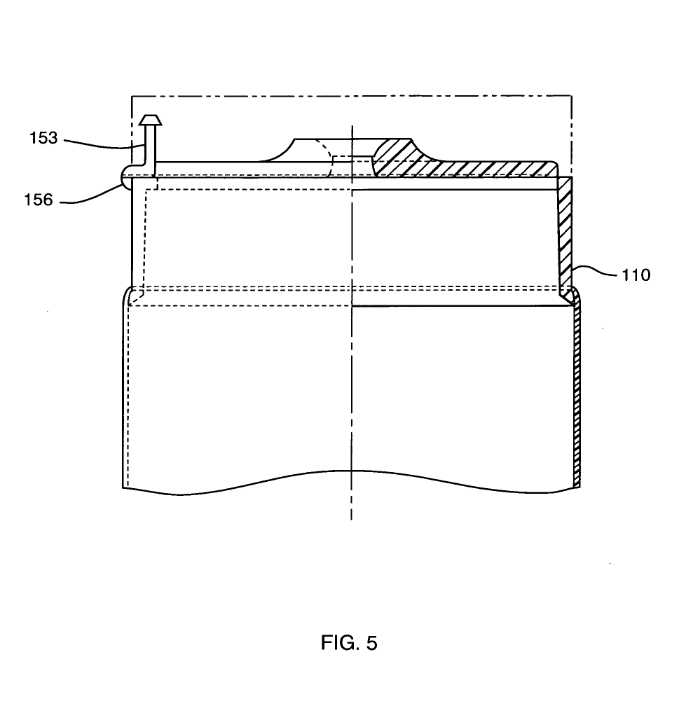

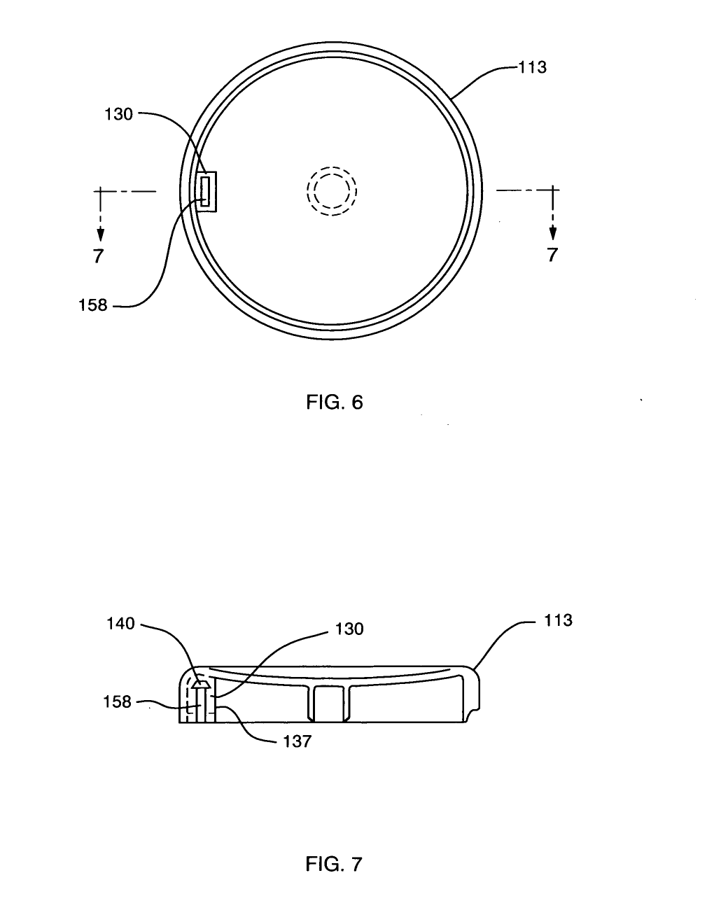

The shoulder element 12 is best understood by a consideration of FIGS. 1 and 2. It includes an end wall 30 and a cylindrical side wall 31. The end wall 30 is bounded by an outer surface 33, and an inner surface 34. The side wall 31 includes an inner surface 35 and an outer surface 36. A recess forming member 37 extends from the inner surface 5 and includes an axial wall 38 and a transverse wall 39. It forms a generally tapered lower edge 41 which engages the proximal end of the tube 21. A dispensing orifice 42 is centrally located in the end wall 30 to be covered and engaged by the lid element 13 when in closed condition.

During manufacture, the shoulder element is injection molded using a mold (not shown) which has an extended end upon which the end 21 of the tube element is engaged, so that while still in relatively molten condition, the end of the tube element is fused with the shoulder element. The lid element is installed thereafter, and moved to closed condition wherein the central projection 58 engages the orifice 42 thereby maintaining the lid element in closed condition. The tube element is then filled and sealed in known manner. When in use, it is necessary only to flip the lid element to opened condition, and squeeze the tube element in known manner, thus permitting simple one-handed manipulation by the user, while preventing the accidental misplacement of the lid element.

The cap element 13 includes a planar wall 50, a cylindrical wall 51, a finger-engaging extension 52, as well as a planar tab portion 53. An area of relatively thin cross section 56 permits pivoting and interconnects a terminal member 57 which, upon assembly, is engaged within the recess 58.

Turning now to the second embodiment of the invention, generally indicated by reference character 110, to avoid needless repetition, certain of the corresponding parts have been designated by similar reference characters with the additional prefix “1”.

In the second embodiment, the recess 158 and the parts which form the recess, namely 127, 138, and 140 are positioned to lie within the interior of the lid element 113. The tab 153 and hinge 156 are correspondingly formed as part of the lid element which is separately injection molded.

It may thus be seen that I have invented novel and highly useful improvements in collapsible tube construction, in which both manufacture and use have been substantially simplified. With respect to manufacture, all of the component parts at the dispensing end of the tube may be formed by injection molding techniques known in the art, and partially assembled by a single heat-sealing operation. With respect to the user, there is provided a flip type closure permanently connected at the dispensing end of the tube, so that the dispensing orifice may be opened and closed as a single-handed operation. The combination includes no threaded parts, thus avoiding the possibility of misplacing a shredded cap element as in known constructions.

I wish it to be understood that I do not consider the invention to be limited to the precise details of structure illustrated and described in the specification, for obvious modifications will occur to those skilled in the art to which the invention pertains.

I claim:

1-4. (canceled)

5. The method of making a collapsible tube for dispensing fluid contents comprising the steps of:
a) providing a hollow flexible tube of heat sealable material having a fluid dispensing end;
b) molding a shoulder element of heat sealable material having an end wall with a centrally disposed dispensing orifice and a side wall simultaneously molded to said end of said tube element; and a plurality of walls forming a recess communicating with said end wall;
c) providing a lid element having an end wall and a peripheral side wall selectively engaging said shoulder element, one of said lid element and shoulder element having a flexible tab extending therefrom; and
d) inserting said tab into said recess;

6. A dispensing collapsible tube construction of synthetic resinous heat sealable material comprising:
a) a hollow tube element of generally cylindrical configuration having a dispensing end;
b) a shoulder element including an end wall having a dispensing opening;
c) a pivotal lid element having a cylindrical wall selectively engaging said shoulder element;
d) At least one of said tube element and lid element forming a recess therein at a peripheral portion thereof, the other of said tube element and lid element having a corresponding flexible tab incorporating hinge means extending therefrom engaging said recess; whereby said lid element may be pivoted between opened and closed positions relative to said dispensing opening by a user.

7. A dispensing collapsible tube construction in accordance with claim 6 in which said tab is formed integrally with said lid element.

8. A dispensing collapsible tube construction in accordance with claim 6 in which said tab is formed integrally with said shoulder element.

9. A dispensing tube construction comprising:
a) a hollow tube element of generally cylindrical configuration having a dispensing end;
b) a shoulder element having an end wall having a dispensing opening therein;
c) a lid element having a cylindrical wall selectively engaging said shoulder element;
d) at least one of said tube element and lid element forming a recess therein at a peripheral portion thereof; and
e) a tab incorporating a hinge interconnecting said hollow tube element and said lid element.
